(19) United States
(12) Patent Application Publication
(10) Pub. No.: US 2017/0371032 A1
(43) Pub. Date: Dec. 28, 2017

(54) CONTROL DEVICE FOR A MOTOR VEHICLE

(71) Applicant: Ford Global Technologies, LLC, Dearborn, MI (US)

(72) Inventor: Peter KOELSCH, Cologne (DE)

(73) Assignee: Ford Global Technologies, LLC, Dearborn, MI (US)

(21) Appl. No.: 15/633,262

(22) Filed: Jun. 26, 2017

(30) Foreign Application Priority Data
Jun. 27, 2016 (DE) 102016211494.8

(51) Int. Cl. G01S 13/62; G06K 9/78; E05F 15/78; B60Q 1/00

(52) U.S. Cl. CPC G01S 13/62; G06K 9/78; E05F 15/78; B60Q 1/0023

(57) ABSTRACT

The disclosure relates to a control device for a motor vehicle, having a sensor unit that is configured to contactlessly detect an object in a sensor zone situated on an outer side of the motor vehicle, and a control unit that is configured to generate a first control signal for at least one actuator according to the detected object, which a movement of an access element can be influenced. In order to improve the reliability and user-friendliness of a control device of a motor vehicle comprising a contactless sensor system, it is provided that the control device comprises a projector unit that is configured to project a light pattern that marks off at least one portion of the sensor zone.

### CROSS-REFERENCE TO RELATED APPLICATIONS

This application claims foreign priority benefits under 35 U.S.C. §119(a)-(d) to DE Application 10 2016 211 494.8 filed Jun. 27, 2016, which is hereby incorporated by reference in its entirety.

### TECHNICAL FIELD

The disclosure relates to a control device for a motor vehicle having a sensor unit configured to contactlessly detect an object in a sensor zone situated on an outer side of the motor vehicle.

### BACKGROUND

In many modern motor vehicles, it is possible to contactlessly control various functions, i.e., without the need for the driver or user to make direct physical contact with the vehicle or the component to be operated. These include, for example, contactless ignition systems, the unlocking of the vehicle by way of the approach by an encoded smartphone, and others. Another contactless system of this type helps the user open the tailgate or stowage compartment lid. In this case, a sensor monitors an area underneath the tailgate. If the user does not have a free hand, he/she can execute a kicking movement using the foot, for example, in the corresponding area, which is detected by the sensor and is recognized by an electronics system coupled thereto. Subsequent thereto, the tailgate is opened by means of an appropriate actuator.

The problem is that the user of such systems, which normally operate invisibly, for example, via infrared, ultrasound or capacitive proximity sensors, cannot determine how large the detection area of the particular sensor is. This can result in the case in which the user executes the correct movement, for example, although in an area where this movement cannot be detected by the sensor. In this case, the user only notices that the desired action (opening the stowage compartment lid or the like) was not carried out. The user does not know why this is, however, since possible sources of error could also be, for example, an incorrect execution of the movement, a malfunction by the vehicle, or other factors. This uncertainty exists, in particular, in the case of a vehicle with which the user is unfamiliar, for example, a rental vehicle.

US 2003/0165048 A1 discloses an input system for an electronic device such as, for example, a mobile telephone, an electronic musical instrument, or an on-board computer of a motor vehicle. The system comprises a sensor system, which can detect the position of an object (for example, a finger) in an active sensor zone on a surface, and a projector which is capable of projecting an image into a projection area of the surface. In this case, the image can represent multiple input fields, within which the object triggers an input. In particular, a virtual keypad can be projected, wherein the positions of the fingers of the user can be detected by emitting infrared rays and receiving reflections thereof.

US 2014/0225860 A1 describes a display device, for example, as part of a vehicle instrument panel, a smartphone, or a tablet, comprising a detector that detects the approach by an object (in particular of one or more fingers) toward the display and subsequently detects an action of the object. In this case, a control unit distinguishes between at least two types of approaches by the object. In this way, in particular, it is possible to distinguish between the approach by a single finger and the approach by multiple fingers, wherein, according thereto, signal lights of different colors or different acoustic signals can be activated.

U.S. Pat. No. 9,147,058 B2 discloses an electronic device comprising a touch-sensitive screen. In order to authenticate a user, a screen for gesture input is displayed, which contains, for example, a series of graphical elements, along which the user can execute a series of movements. Within the scope of establishing an authentication gesture, the user can repeatedly practice the gesture, wherein the extent to which the gesture was correctly executed can be displayed via different colors of the elements.

KR 10 2015 110257 A describes a device to be worn in the manner of eyeglasses, comprising an image sensor that detects a gesture of the user and therefore defines a virtual input interface. The virtual input interface is projected into the field of view of the user, who can then execute certain input actions at the interface by means of gestures that, in turn, are detected by the image sensor.

US 2012/0287050 A1 describes a system for providing an interface between a driver of a vehicle and a computer. In this case, a projector is situated in the vehicle, by means of which an image of a virtual keypad is projected onto a driver-side surface of the steering wheel or instrument panel. By means of a gesture sensor, finger movements of the driver relative to different virtual buttons are registered. The computer is connected to the gesture sensor and detects the selection of individual keys by way of the movements. Optionally, the virtual keypad can also be utilized, in part, as a type of touchpad.

DE 10 2013 226 188 A1 discloses a lamp for illuminating a surrounding environment for a motor vehicle, which projects the status of a drive battery onto a surface. The surface can be a wall of a building, a surface of the vehicle itself, or, in particular, the ground under the vehicle. The lamp for illuminating a surrounding environment is preferably integrated into the underside of an exterior mirror. The activation can take place by way of the unlocking of the vehicle via a radio key.

In light of the aforementioned prior art, the reliability and user-friendliness of a control device of a motor vehicle comprising a contactless sensor system still has room for improvement. This applies, in particular, for control devices of access elements such as doors, stowage compartment lids, or the like.

### SUMMARY

The problem addressed by the disclosure is that of improving the reliability and user-friendliness of a control device of a motor vehicle comprising a contactless sensor system.

It should be noted that the features and measures mentioned individually in the following description can be combined with one another in any technically reasonable manner and can reveal further embodiments of the disclosure. The description additionally characterizes and specifies the disclosure in particular in connection with the figures.

By way of the disclosure, a control device for a motor vehicle is made available. The motor vehicle can be a road vehicle such as, for example, a passenger car, a minivan, a transporter, or a truck. Applications for motorcycles, trikes, or quads are conceivable but are not central to the disclosure. The motor vehicle can be, for example, a motor vehicle comprising an internal combustion engine, an electric motor, or a hybrid drive.

The control device comprises a sensor unit that is configured to contactlessly detect an object in a sensor zone situated on an outer side of the motor vehicle. The term “sensor unit” is to be broadly interpreted in this case and does not mean that this unit must be located in a certain vehicle area. The sensor unit can comprise one or a plurality of sensors, which can be spaced optionally far apart from each other. These can be active or passive sensors. In the case of active sensors, which comprise at least one transmitter and at least one receiver, transmitter and receiver can be situated directly next to one another or further apart from one another. Different types of sensors can also be combined with one another, i.e., for example, optical sensors, radar sensors, and/or ultrasonic sensors. This list is to be understood purely as an example and is not exhaustive. With regard to the detection of objects, the sensor unit is naturally limited to a certain area, which is referred to as the sensor zone in this case. This can be a solid angle, for example, in this case of a single sensor. The sensor zone is normally contiguous, although this is not mandatory. In particular, it would be conceivable that the sensor zone comprises one or multiple cutouts, i.e., is designed as a type of ring, for example. With regard to the object, it is possible that the sensor unit detects only certain types of objects, for example, objects having a certain size or objects having a certain temperature, which, for example, approximately corresponds to a human body temperature.

In addition, the control device comprises a control unit that is configured to generate a first control signal for at least one actuator of the motor vehicle according to the detected object, which a movement of an access element of the motor vehicle can be influenced. The control unit can be specifically assigned to the control device, in this case, and can be optionally located close to the sensor unit. It is also possible, however, that the control unit is integrated at least partially into an on-board computer or another device that has additional functions, which are not related to the control device. It is also possible that the control unit consists of a plurality of physically interspaced subunits that are normally electrically interconnected, however. The control unit can be partially implemented in the form of software, of course. The control unit generates the first control signal according to the detected object. This means that at least one object must be detected in order for the first control signal to be generated. Embodiments are possible, however, in which simply detecting is insufficient and, instead, the object must have, e.g., a certain property (size, shape, or the like) or must move in a certain way. It is understood that the control unit must be connected to the sensor unit, which includes the possibility of a wireless connection. The connection is normally implemented in a wired manner, however. Control signals for one or multiple actuators can be generated, wherein the at least one actuator is, in particular, a motor-driven, i.e., movement-generating actuator.

In this case, a movement of an access element of the motor vehicle can be influenced by the actuator. Access elements in this case are all doors, hoods, covers (for example, a tank cap or a charging cap of an electric car or a plug-in hybrid vehicle), lids and gates, as well as tiltable or displaceable windows or window panes, i.e., all elements that permit entry or access to the vehicle interior, the trunk, the engine compartment, a filler neck, a charging socket or the like. These access elements are situated on the outside of the vehicle and can be opened and closed. They can also be locked. The actuator can actively move the access element in this case, or the actuator can, for example, trigger a locking action, after which the access element executes the movement itself by way of being acted upon in a static manner. In particular, the actuator can be designed for effecting an opening of the access element.

According to the disclosure, the control device also includes a projector unit, which is configured to project a light pattern that marks off at least one portion of the sensor zone. The projector unit can optionally also be implemented by multiple subunits, which can also be spaced far apart from each other. Overall, the projector unit can project the light pattern, wherein the term “light” relates to visible light in this case. In addition, the projector unit could also project non-visible light components, which is inconsequential for the implementation of the disclosure, however. The term “pattern” is to be interpreted very broadly in this context and, in the broadest sense, includes any light distribution that is not identical in all directions. In this way, a light cone, for example, would also be suitable for projecting a light pattern provided it is limited on all sides. The projector unit can be configured to project a light pattern that corresponds to a sharp image in an intended projection plane. For this purpose, the projector unit can include optical elements such as lenses or prisms. The projector unit also comprises at least one light-generating element, of course, for example, a laser or an LED. It is possible that the light pattern has many colors. It is also preferred, as will be explained below, that the projector unit is configured to project different light patterns, or change the light pattern over time. The light pattern marks off at least one portion of the sensor zone, i.e., it is structured in such a way that a user can recognize where this portion of the sensor zone, or the sensor zone as a whole, is located. The light pattern is therefore normally limited to the sensor zone or the aforementioned portion of the sensor zone, even though deviations therefrom would be possible, e.g., in the form of projected arrow symbols that point to the boundary of the sensor zone, but are situated outside of the sensor zone. The projection of the light pattern is located in a certain plane, or on a certain surface that is spaced apart from the project unit. In this case, the light pattern is dimensioned in such a way that it marks off the sensor zone in this plane or on this surface. Outside of the surface, the distribution of light that is responsible for the light pattern can deviate substantially from the (overall three-dimensional) sensor zone under certain circumstances. Normally, although not absolutely necessary, the projector unit is situated in the area of the access element and the light pattern is projected close to the access element. In particular, the access element can be a stowage compartment lid, which, for example, can be opened via a sensor unit situated in the area of the underbody or on the lid itself.

Even though a functional distinction is made here between the sensor unit and the projector unit and these are normally also actually physically distinguishable, it is conceivable within the scope of the disclosure that the projector unit forms a portion of the sensor unit, wherein the projected light pattern marks off the sensor zone, on the one hand and, on the other hand, is also used for scanning the sensor zone or a portion thereof, for example, in the manner of a scanner. The units mentioned here, i.e., the control unit, the sensor unit, and the projector unit, are understood to be functional units within the control device. It is understood that two or all three of the aforementioned units can be designed so as to be integrated, for example, on the same circuit board.

Due to the projection of the light pattern, the user is provided with a visual indication of the position and the extension of the sensor zone. In the case of a vehicle with which the user is not familiar, it is therefore also possible for the user to directly determine whether a detection of an object (for example, a foot or another body part of the user) is even possible. The user-friendliness is substantially increased as a result and the number of sources of error is reduced.

As mentioned above, the sensor zone is situated on an outer side of the motor vehicle. In this case, the projector unit and the sensor unit are usually situated at least partially on the outer side of the vehicle. By means of such a sensor zone it is possible for the user to influence certain actuators outside of the vehicle. One typical example is the control of an aforementioned stowage compartment lid.

The control unit is preferably configured to generate the first control signal upon detection of a first movement of the object. The term “first movement” does not relate, in this case, to any particular temporal sequence or any other type of sequence, but rather is used only for the purpose of differentiating from a second movement, which will be discussed further below. In this embodiment, the first control signal is therefore not triggered simply by the presence of an object in the sensor zone, but rather by the object executing the aforementioned first movement. In particular, the type of movement, for example, its direction, speed or distance covered, that is necessary in order for the first control signal to be sent, can be predefined. The type of the movement is normally predefined with a certain tolerance, of course, in order to not adversely affect the user friendliness. The object is preferably a body part, in particular a foot of a user, and the control unit is configured to generate the first control signal upon detection of a bodily movement of the user, i.e., a movement of the body part.

There are different possibilities with regard to where the light pattern can be projected. The light pattern could be projected, for example, onto a surface of the vehicle or even onto surrounding walls or ceilings, provided this makes sense in conjunction with the sensor zone. The projector unit is preferably configured to project the light pattern onto the ground. This is intended to mean the ground or the supporting surface on which the motor vehicle is resting (or traveling, which is normally not the case during the use of the control device, however). This means that the sensor zone is likewise located, at least partially, close to the ground. In this case, a foot of a user, in particular, can be used as the object that is detected by the control unit. In this case, the sensor unit can be situated in a lower region of the motor vehicle, in particular in the area of the vehicle underbody.

Preferably at least one portion of the light pattern is situated along an edge of the sensor zone. This means the light pattern includes a portion, for example, in the form of a closed or interrupted line, which is situated along the edge of the sensor zone. Such a line can also be displayed, for example, in the form of an animation, for example, by way of the animation flashing, rotating or changing in terms of its thickness or its color. In addition, the light pattern can contain further elements, for example, image or text elements. The boundary marked off by the light pattern can also be slightly larger or slightly smaller than the actual sensor zone, of course, i.e., the boundary does not need to be congruent with the edge of the sensor zone. In this way, for example, in the case of a control by means of a foot movement by the user, it cannot be assumed that the sensor zone must be marked off with an accuracy of 1 cm or less. The portion that is situated at the edge of the sensor zone can be designed as a frame element.

According to one preferred embodiment, the first movement is indicated by means of the light pattern. This can take place, for example, by means of a static display, which indicates—in the form of a motion arrow and/or a simplified representation of a body part of the user who executes the movement, —which movement is to be carried out. Moreover, it is also conceivable, however, that the movement is visualized in the form of an animation, i.e., using moving images. This can mean, for example, that a motion arrow moves in the direction in which it points, or that a symbol, for example, that represents a foot or another body part of the user, moves in the way in which the first movement is to be carried out.

In addition to marking off the sensor zone and in addition to the optional, aforementioned function that indicates the first movement to be carried out, other functions that assist a user can also be provided. According to one embodiment, the control unit is configured to trigger a feedback signal, which is perceptible to a user upon detection of the object. The feedback signal is triggered by the control unit but need not be generated by the control unit itself; instead, the control unit can control another unit (e.g., the projector unit) in such a way that this unit generates the signal. In particular, the feedback signal can be triggered upon detection of the first movement. Such a feedback signal is advantageous in the cases, in particular, in which the function influenced by the actuator is not clearly perceptible or is not immediately perceptible to the user. The user therefore does not need to wait for his/her action to take effect, but rather immediately receives feedback that a movement, for example, was detected. The feedback signal can be, in particular, visually or acoustically perceptible to the user. This can be a combined signal or multiple signals, of course. In the case of an acoustic signal, an announcement by way of a computer voice can take place, which describes the handling triggered by the actuator, e.g., “trunk is opening”, or the like. A visual signal could be generated, for example, by a signal lamp provided specifically for this purpose, or by a light source that is present anyway, such as a flasher or a tail lamp, or a projection within this light source.

The control unit is preferably configured to change the light pattern upon detection of the object. Specifically, the control unit is configured to control the projector unit in such a way that the light pattern changes. Therefore, as a reaction to the detection of the object—or, in particular, as a reaction to the detection of the first movement—a light pattern is generated that differs from the light pattern generated before the detection. In this case, the color and/or the shape of the light pattern can be changed. This means it would also be possible that the light pattern remains unchanged in terms of shape and/or extension and merely changes its color, for example, from red to green. It is also possible in this case that a type of animation in the form of moving images is played. A short piece of text or a pictogram, which verifies that the detection has taken place or the action has been triggered, could also be projected.

In some cases, the first control signal triggers an action in which the user can optionally engage. One example would be opening a stowage compartment lid, which the user would possibly like to open by only a certain extent and the movement of which should be stopped at this certain extent. For such cases, the control unit according to one preferred embodiment is configured in such a way that, after the first movement has been detected and a second movement is detected, a second control signal is generated for an actuator of the motor vehicle. In this case, the second movement can be physically identical to the first movement, i.e., it is possible that the same movement is carried out twice, with the result the first time that the first control signal is carried out and with the result the second time that the second control signal is carried out. The first and the second control signals can be preferably determined for the same actuator or for the same actuators. It is also possible, however, that the second control signal is determined for one or more actuators that are not affected by the first control signal. One typical example of a first and a second control signal, in the case of opening a stowage compartment lid, would be that the first control signal actuates an actuator that opens the stowage compartment lid, while the second control signal stops the corresponding actuator.

Advantageously, the control unit is configured in this case to change the light pattern in such a way that the second movement is displayed. This is to be understood, in turn, to mean that the control unit controls the projector unit in such a way that the light pattern is changed in this way. The second movement, as is likewise the case with the first movement, can be indicated, for example, by means of directional arrows or by a representation of a body part of the user that executes the movement. In this case as well, an animation in the form of moving images is possible. It is also possible, of course, that the color of the light pattern changes. Text or a combination of images and text can be projected. The indication of the second movement can take place as an alternative to the aforementioned actuation signal or subsequent thereto. In this way, the light pattern could be initially changed for the purpose of confirmation, wherein the corresponding representation is retained only for a few seconds, after which the light pattern is changed a second time as a prompt for the second movement.

Further advantageous details and effects of the disclosure are described in greater detail in the following with reference to an exemplary embodiment represented in the figures. Therein:

### BRIEF DESCRIPTION OF THE DRAWINGS

FIG. 1 shows a rear view of a motor vehicle comprising a control device according to the disclosure;

FIG. 2 shows a perspective view of the motor vehicle from FIG. 1 at a first point in time;

FIG. 3 shows a perspective view of the motor vehicle from FIG. 1 at a second point in time; and

FIG. 4 shows a perspective view of the motor vehicle from FIG. 1 at a third point in time.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

Identical parts are always provided with the same reference numbers in the different figures, and so these parts are also generally only described once.

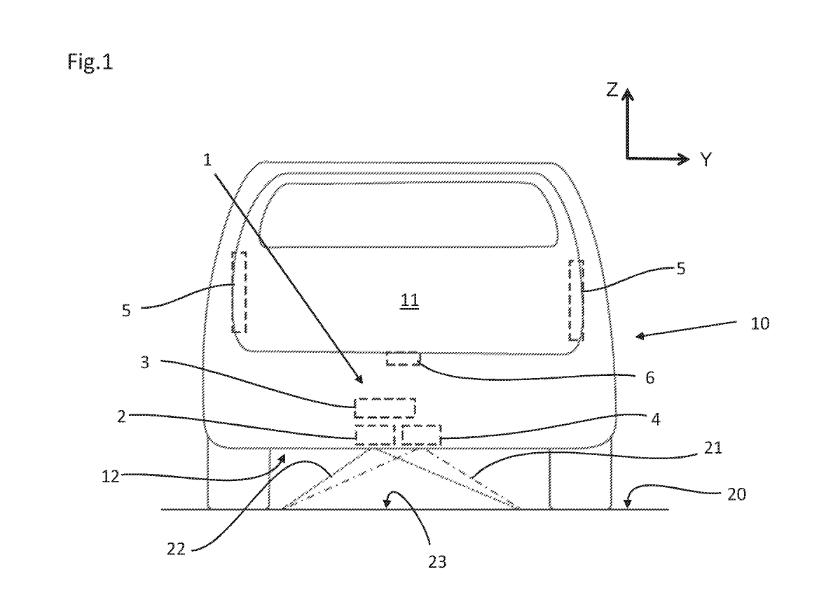

FIG. 1 shows a rear view of a motor vehicle 10, which is designed as a type of SUV in the present case, by way of example. The x-axis, y-axis, and z-axis of the motor vehicle 10 are plotted here and in the further figures for the purpose of better orientation. As is apparent, there is a stowage compartment lid 11 in the rear area, which can be raised via, e.g., two actuators 5 designed as motor-driven lid lifting mechanisms 5 in the exemplary embodiment, and which can be locked or unlocked via another actuator 6 designed as a motor-driven closing element or as a so-called closing aid 6 in the exemplary embodiment.

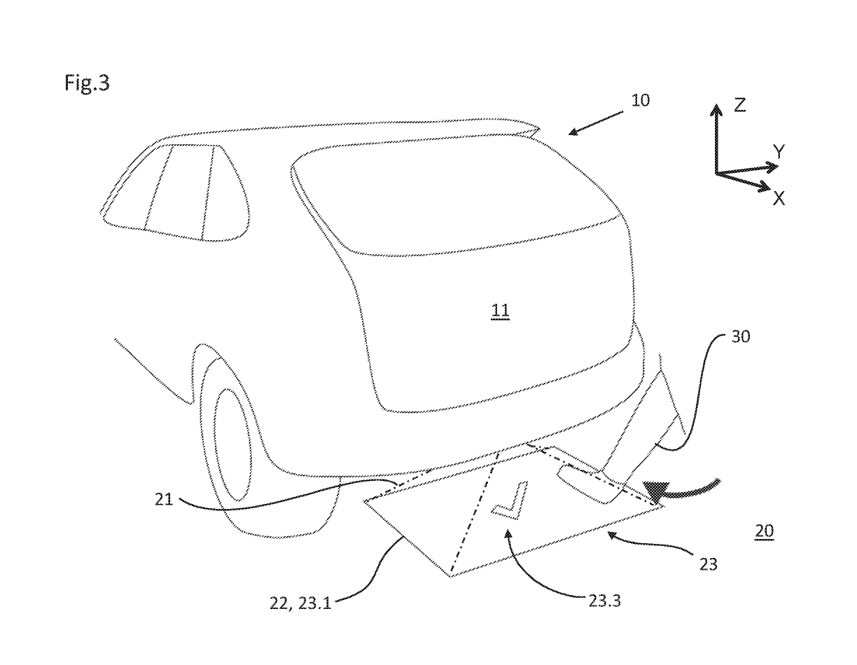

A control device 1 is situated close to the underbody 12 of the motor vehicle 10, via which the lid lifting mechanism 5 as well as the closing aid 6 can be controlled. More precisely, this takes place via a control unit 3, which is connected to the aforementioned actuators 5, 6 via control lines that are not shown here. The control unit 3 is connected, on the one hand, to a sensor unit 2, which can be designed, for example, as an ultrasonic sensor. In this case, a sensor zone 22 of the sensor unit 2 is marked off by a dashed line. This sensor zone 22 is monitored by the sensor unit 2, i.e., a presence and position of an object can be determined in this area. If a user, as represented in FIG. 3, executes a kicking movement with his/her leg 30 in the sensor zone 22, this is detected by the control unit 3, which is connected to the sensor unit 2, as a first movement, which results in the control unit 3 unlocking the closing aid 6 and lifting the stowage compartment lid 11 via the lid lifting mechanisms 5.

In order to show the user, on the one hand, the possibility of opening the stowage compartment lid 11 by means of the described kicking movement and, on the other hand, to make it clear to him/her where the sensor zone 22 is located, in which the kicking movement can be detected, a projector unit 4 is furthermore provided, which projects a visible light pattern 23 onto the ground 20 —for example, by means of a laser or at least an LED—on which the motor vehicle 10 is resting. In this case, the boundaries of a beam 21 that is responsible for the light pattern 23 is indicated by means of dash-dotted lines in FIG. 1. The beam 21 deviates from the sensor zone 22 in the upper area, but is oriented in such a way that it coincides with the extension of the sensor zone 22 in the area of the ground 20.

In the example shown, the sensor unit 2 and the projector unit 4 are situated in the area of the underbody 12. It would also be conceivable, however, that at least one of the units 2, 4 would be situated in the stowage compartment lid 11 itself. Likewise, the control unit 3 could be situated so as to be spatially separated from the sensor unit 2 and/or the projector unit 4 and, for example, could be integrated in another control device.

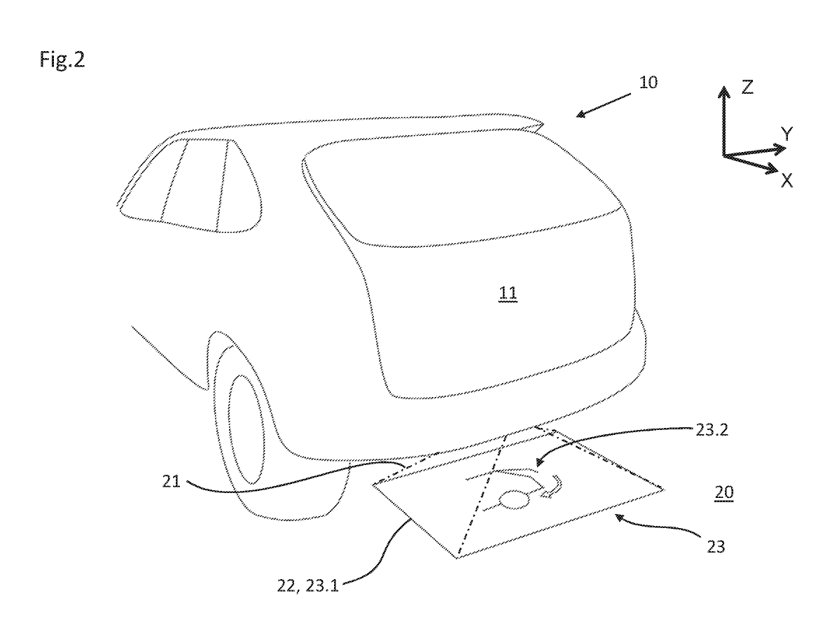

As is evident in the perspective view in FIG. 2, the light pattern 23 is subdivided into a frame element 23.1 and a signal element 23.2. The frame element 23.1 is situated along the edge of the sensor zone 22 and therefore clearly shows a user where the sensor zone 22 begins and ends. In the present case, the frame element 23.1 is congruent with the edge of the sensor zone 22, although it could deviate slightly therefrom to a slight extent, for example, by a few centimeters. In order to also make it clear to the user which function can be triggered via the sensor unit 2 and how this takes place, the signal element 23.2 schematically represents the rear end of the motor vehicle 10 with an opened stowage compartment lid 11, wherein a directional arrow in the lower area indicates the kicking movement to be carried out by the user. The light pattern 23 can consist of one or more colors and, for example, could be designed to be red overall. As an alternative or in addition to the signal element 23.2, a text element could also be projected. The signal element 23.2 could also be animated, for example, by way of a moving representation of an opening stowage compartment lid.

FIG. 3 shows the leg 30 of the user, which the user (as indicated by the bold arrow) executes a kicking movement within the sensor zone 22. The kicking movement is detected by the sensor unit 2 and is evaluated and detected by the control unit 3, which, on the one hand, results in the control unit sending appropriate control signals to the closing actuator 6 and to the lid lifting mechanisms 5 and, on the other hand, results in the control unit controlling the projector unit 4 in such a way that it changes the light pattern 23. In order to provide the user with visual feedback regarding the successful detection procedure, the signal element 23.2 is replaced by another signal element 23.3 in the form of a checkmark. The latter can also be represented in another color, for example, green. It is also possible to allow the frame element 23.1 to change color in this case. Alternatively or in addition to the visual indication by the light pattern 23, an acoustic signal could be played or a computer voice could be played, which speaks a confirmation message.

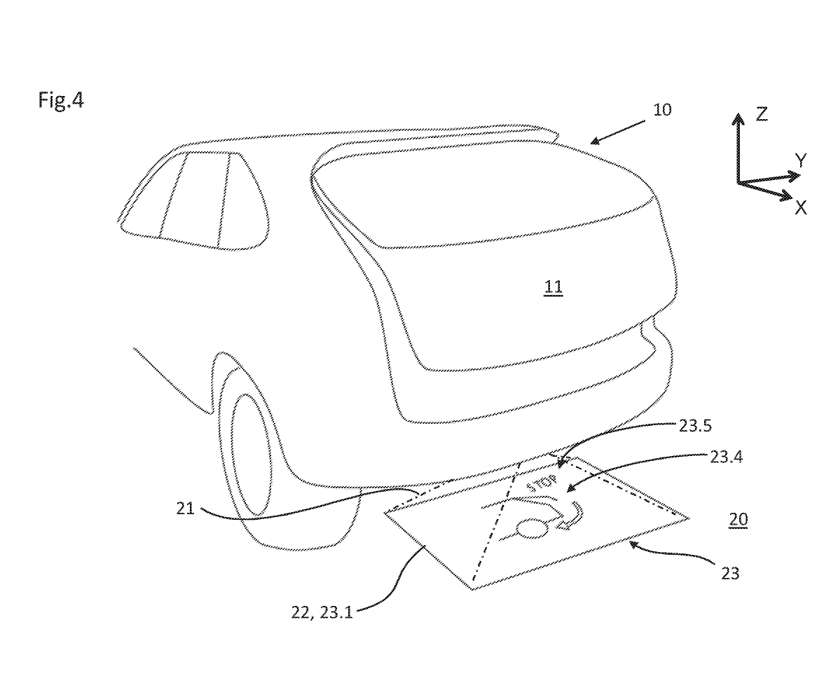

FIG. 4 shows an optional expansion of the functions of the control device 1, wherein the user is able to stop the movement of the stowage compartment lid 11 by executing another kicking movement. In order to show the user this option, a signal element 23.4 is projected, which is essentially similar to the signal element 23.2 shown in FIG. 2, wherein a text element 23.5 has been added above the opened stowage compartment lid, which indicates the option to stop the stowage compartment lid 11. It is possible that the light pattern 23 represented in FIG. 3 is displayed for 1 to 2 seconds and then the representation switches to the light pattern according to FIG. 4. If the user executes the kicking movement again, this is detected by the control unit 3 by the sensor unit 2, whereupon the control unit 3 sends control signals to the lid lifting mechanisms 5, and so these are stopped and the stowage compartment lid 11 comes to a standstill. In this case as well, a confirmation can optionally take place again, for example, by means of a light pattern that is similar or identical to the light pattern in FIG. 3.

In the exemplary embodiment shown, the stowage compartment lid 11 is contactlessly controlled. It is understood that another access element of the motor vehicle 10, for example, a door, an engine hood, a filler neck, a charging cap of the electric car, or the like, can be controlled in a similar way. If this is advantageous, then, in deviation from the exemplary embodiment shown, the projector unit 4 can project the light pattern 23 not onto the ground 20, but rather, for example, onto a surface of the motor vehicle 10 or onto a surrounding wall or ceiling.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A vehicle control device comprising:
a sensor configured to contactlessly detect an object in a zone situated on an outer side of a motor vehicle;
a control unit configured to generate a first control signal for at least one actuator according to the detected object such that a movement of an access element is influenced; and
a projector unit configured to project a light pattern that marks off at least one portion of the zone.

2. The control device as claimed in claim 1, wherein the control unit is further configured to generate the first control signal upon detection of a first movement of the object.

3. The control device as claimed in claim 2, wherein the first movement is indicated via the light pattern.

4. The control device as claimed in claim 2, wherein the control unit is further configured to, in response to the first movement and a second movement, generate a second control signal for at least one actuator of the motor vehicle.

5. The control device as claimed in claim 4, wherein the control unit is further configured to change the light pattern such that the second movement is displayed.

6. The control device as claimed in claim 1, wherein the projector unit is further configured to project the light pattern onto a ground surface.

7. The control device as claimed in claim 1, wherein the control unit is further configured to trigger a feedback signal perceptible to a user, upon detection of the object.

8. The control device as claimed in claim 7, wherein the control unit is further configured to change the light pattern, upon detection of the object.

9. The control device as claimed in claim 1, wherein the light pattern includes at least one portion situated along an edge of the zone.

10. The control device as claimed in claim 1, wherein the access element is a stowage compartment lid.

11. A vehicle comprising:
a sensor that detects an object in a zone situated on an outer vehicle side;
a projector that projects a light pattern having a frame element being a line along an edge of a portion of the zone; and
a control unit configured to, in response to detection of a first movement within the frame element, generate a first control signal based on the first movement to actuate a stowage compartment lid.

12. The vehicle as claimed in claim 11, wherein the frame element is projected onto a ground surface.

13. The vehicle as claimed in claim 11, wherein the control unit is further configured to, in response to the first movement, trigger a feedback signal perceptible to a user.

14. The vehicle as claimed in claim 11, wherein the control unit is further configured to, in response to the first movement, change the light pattern.

15. The vehicle as claimed in claim 11, wherein the control unit is further configured to, in response to the first movement and a second movement, generate a second control signal to actuate the stowage compartment lid, and change the light pattern such that the second movement is displayed.

16. A sensor system for a vehicle comprising:
a control unit configured to, in response to detection, via a sensor, of a first movement within a frame element of a light pattern, the frame element being a line along an edge of a portion of a zone situated on an outer vehicle side displayed via a projector, generate a first control signal based on the first movement to actuate a stowage compartment lid.

17. The sensor system as claimed in claim 16, wherein the frame element is projected onto a ground surface.

18. The sensor system as claimed in claim 16, wherein the control unit is further configured to, in response to the first movement, trigger a feedback signal perceptible to a user.

19. The sensor system as claimed in claim 16, wherein the control unit is further configured to, in response to the first movement, change the light pattern.

20. The sensor system as claimed in claim 16, wherein the control unit is further configured to, in response to the first movement and a second movement, generate a second control signal to actuate the stowage compartment lid, and change the light pattern such that the second movement is displayed.
